(19) United States
(12) Patent Application Publication
(10) Pub. No.: US 2006/0135146 A1
(43) Pub. Date: Jun. 22, 2006

(54) Telecommunications system and a method of operating the system

(75) Inventor: Paul Bucknell, Brighton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/046,292

(22) Filed: Jan. 15, 2002

(30) Foreign Application Priority Data
Jan. 17, 2001 (GB) 0101205.3

(51) Int. Cl. H04Q 7/20

(52) U.S. Cl. 455/422.1; 455/450

(57) ABSTRACT

A telecommunications system, such as a cellular telephone system, comprises at least one primary station (12) and a plurality of secondary stations (14) which are able to communicate with each other in accordance with any suitable protocol embedded as software in the respective stations. Software configuration or reconfiguration in the secondary stations is effected over the air using a transmitter other than the primary station(s). Such a transmitter may comprise a broadcast transmitter (16) having spare capacity which can be used for purposes other than broadcasting.

The present invention relates to a telecommunications system, to a method of operating the system and to a secondary station for use in the system. The present invention has particular, but not exclusive, application to mobile telecommunications systems, such as cellular telephone systems, in which secondary stations in the form of portable wireless terminals can roam with respect to fixedly sited primary stations.

In contemporary telecommunications practice it is more than likely that a user will roam into geographical areas or countries in which the operating standard or protocol is different from a neighbouring area or country or access to one of several concurrently operating systems is not possible because of say congestion. As a consequence, in order to avoid the user having to carry several portable phones, each being adapted to operate in accordance with a particular standard, it is desirable that the user has one phone which can adapt itself to the currently available telecommunications system. In order that a portable phone can adapt not only to new systems for which it does not have the required software but also to upgrades of existing software, it has been frequently necessary for the user to take or send the mobile phone to a service centre or service provider to have the desired software changes effected.

Alternatively it may be possible to update the portable phone in other ways such as over the air by transmissions from the service provider by using the installed radio network. However the downloading of large amounts of software over the air interface to portable terminals would demand considerable bandwidth from the operator, which bandwidth could otherwise be used to generate revenue from users making calls or data traffic.

U.S. Pat. No. 5,852,721 discloses a data transfer system using high speed, one-way links such as satellites and cable television lines and low-speed networks as dial up telephones, ISDN D-channel, and low-speed satellite paths. A requesting terminal includes an interface that allows a user to select whether data downloaded from a network is transmitted to the requesting terminal via a high speed link or a lower speed link.

U.S. Pat. No. 5,553,314 discloses configuring a cellular phone at start-up by the phone transmitting an application request to a portable configuration device over a secondary communication path, the device ascertains the appropriate information and transmits it back to the phone over the secondary communication path. Thereafter the phone is able to establish a primary two-way communication path with a basestation. Any updates in configuration data are effected to the portable configuration device by updating or replacing it and not to the phone itself.

U.S. Pat. No. 5,689,825 discloses updating software to portable wireless communication units by placing the unit in a battery charger/software downloader which is coupled to the public communication network, which in turn is coupled by way of a server to a wireless network.

None of these proposals lend themselves to updating over the air configuration software held in a portable wireless terminal.

An object of the present invention is to be able to update configuration software held in a wireless terminal without adversely affecting significantly the revenue raising capacity of the wireless phone network.

According to a first aspect of the present invention there is provided a method of operating a radio system comprising a primary station and at least one secondary station, characterised by establishing a two-way communications link between the primary station and the at least one secondary station, by the primary station transmitting a configuration message to the at least one secondary station, by the at least one secondary station adapting itself to receive configuration information signals transmitted by a source other than the primary station.

According to a second aspect of the present invention there is provided a telecommunications system comprising a primary station and at least one secondary station, characterised in that the primary station has means for establishing a two-way communications link between it and the at least one secondary station, in that the at least one secondary station has means responsive to a configuration message transmitted by the primary station for preparing the secondary station to receive configuration message signals transmitted over at least a one-way channel other than the two-way communications link established between the primary station and the at least one secondary station.

According to a third aspect of the present invention there is provided a secondary station for use in a telecommunications system comprising a primary station and the secondary station, the primary station having means for establishing a two-way communications link between it and the secondary station, characterised in that the secondary station has means responsive to a configuration message transmitted by the primary station for preparing the secondary station to receive configuration message signals transmitted over at least a one-way channel other than the two-way communications link established between the primary station and the secondary station.

By means of the present invention a source, separate from the primary station, is used to transmit configuration information signals to the secondary stations whilst avoiding reducing significantly the revenue raising capacity of the telecommunications system. If desired the source may comprise a broadcast system in which time can be purchased for the transmission of signals other than the normal radio or television signals. Advantages of using a broadcast system include the fact that the infrastructure already exists and the radio coverage area is extensive and includes areas having difficult topology.

The (or each) secondary station may include a separate receiver for receiving configuration signals from the said source or may have a receiver which can be reconfigured in response to instructions transmitted by the primary station(s).

The present invention will now be described, by way of example, with reference to the accompanying drawings, wherein:

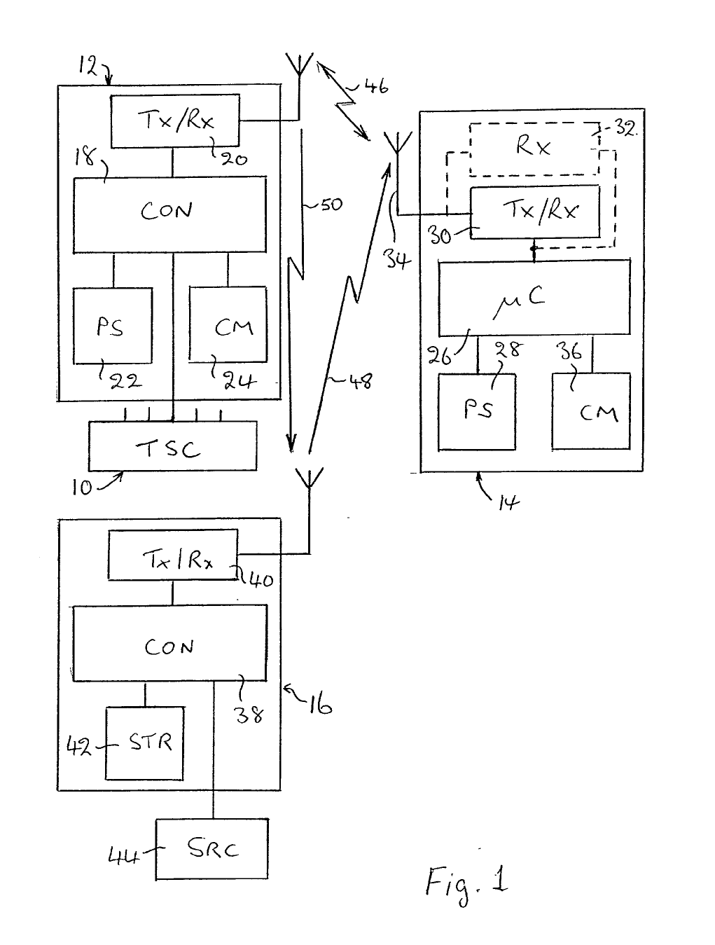

FIG. 1 is a block schematic diagram illustrating a simplified embodiment of a communications system, and

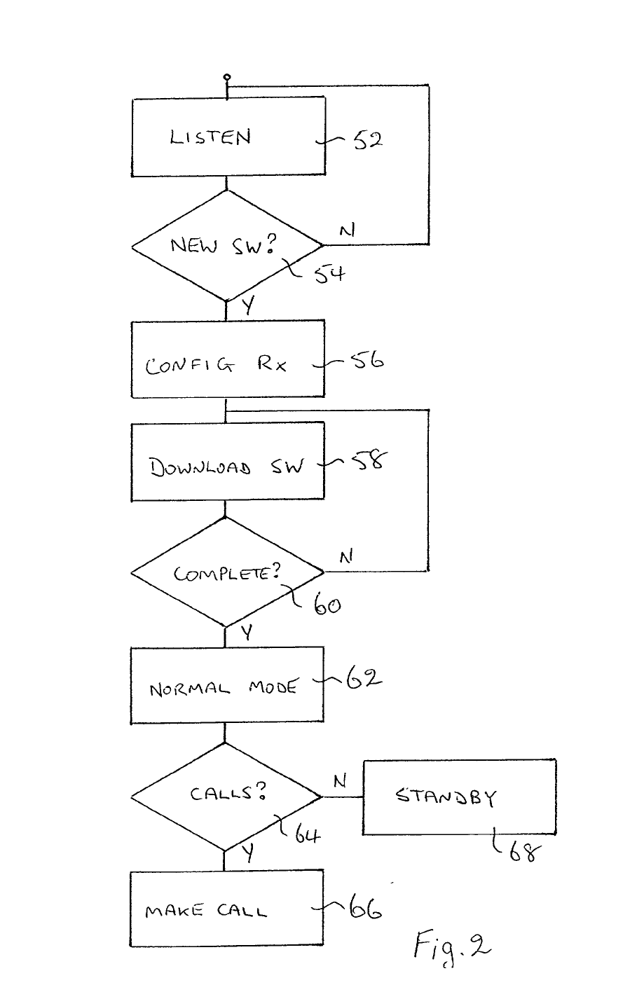

FIG. 2 is a flow chart relating to configuring the software stored in a secondary station using a broadcast signal.

In the drawings, the same reference numerals have been used to indicate corresponding features.

Referring to FIG. 1, the simplified communications system comprises a trunking system controller (TSC) 10 which is connected by for example landlines or microwave links to a plurality of geographically spaced primary (or base) stations 12 of which one is shown in FIG. 1. A plurality of secondary stations 14 in the form of portable wireless terminals, only one of which is shown, are carried by users who are able to roam whilst maintaining communication in the radio coverage areas of the respective primary stations, the radio coverage areas generally being termed cells. Also shown in FIG. 1 is a broadcast system 16 represented by a single site.

The TSC 10 comprises a large computer installation which under software control operates the network of primary and secondary stations in accordance with one or more approved standards such as 3G (or UMTS) and GSM.

Each primary station 12 includes a controller (CON) 18 which operates in accordance with software stored in a memory (not shown). The controller 18 is connected to one or more transceivers 20, to a protocol stack (PS) 22 which stores operating details of the protocol(s) being used and to a configuration manager (CM) 24 which initiates configuration changes to the secondary station 14.

The secondary station 14 comprises a microcontroller (μC) 26 which operates in accordance with software stored in a memory (not shown) and the protocol(s) stored in a protocol stack 28. A transceiver 30 is coupled to the microcontroller 26. If the transceiver 30 is not configurable, that is not capable of adapting itself to signals transmitted on carriers having frequencies and/or modulation schemes significantly different from those used by the communications system, then another receiver 32, such as a broadcast receiver, is coupled between an antenna 34 and the microcontroller 26 as shown in broken lines. A configuration manager 36 is also coupled to the microcontroller 26.

In normal operation, telephone or data calls to and from the secondary station 14 are by way of the primary station 12. However if it is necessary to download new or updated configuration software to the secondary station 14 this would required considerable capacity, for example 2 Mbytes, from the system operator if done over the cellular network. This would have the effect of reducing significantly the available revenue earning capacity from the network.

In the system in accordance with the present invention, configuration software is relayed to the secondary station by a source other than the primary stations 12. This source is the broadcast system 16. In a simplified form, the system 16 comprises a controller 38 which is coupled to a transceiver 40, to a store (STR) 42 containing configuration data to be relayed and to a source (SRC) 44 of radio and/or TV broadcast signals. In the transmission of say TV signals, it is known that there are periods in each frame when the signal content is low or non-existent and other signals, such as teletext signals, can be transmitted. In implementing the operating method in accordance with the present invention, the cellular network operator purchases some of this unused capacity from the broadcaster and uses it to transmit configuration data substantially continuously. The primary stations 12 transmit control messages 46 to the secondary stations 14 over the cellular network. These control messages inform the secondary stations how to configure themselves to receive software downloaded by a broadcast signal 48.

The primary stations 12 also transmit signals 50, including updated configuration software, to the broadcast system 16 for storage in the store 42 and subsequent relay onto the secondary stations 14.

The control messages 46 are two-way thereby enabling the user of the secondary stations 14 to negotiate when and if the software is to be upgraded. Since the transmission of an upgrade in the software may take a relatively long time and may incur additional costs to the user, the user may prefer to defer effecting an upgrade until a more convenient time or may decline to be upgraded as he/she has no desire to incur additional costs. If a user or secondary station 14 transmits a control signal confirming that the software configuration has been completed, the TSC 10 can determine what proportion of the total number of secondary stations have been upgraded.

Referring to FIG. 2, block 52 denotes the secondary station 14 listening to control messages. Block 54 denotes the secondary station 14 being asked if it wants to receive new software at the next update. If the answer is No (N), the flow chart reverts to the block 52. If the user decides that he/she wants to receive the new software (Y) then in block 56 either the transceiver in the secondary station configures its receiver section or selects the receiver 32 in order to be able to receive the broadcast signals 48. Block 58 denotes the downloading of the software. In block 60 a check is made to see if the download of software is complete. If the answer is no (N) the flow chart reverts to the block 58 but if the answer is yes (Y) then in block 62, the secondary station terminates the reconfiguration operation and the transceiver reverts to its normal mode for communication with the respective primary station 12.

In block 64 the secondary station checks whether there are any calls from the primary station to be stored or responded to or if the user wishes to make an outgoing call. If so (Y), the secondary station sets-up a call but if not (N), it enters a standby mode.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of communication systems and component parts therefor and which may be used instead of or in addition to features already described herein.

1. A method of operating a radio system comprising a primary station and at least one secondary station, characterised by establishing a two-way communications link between the primary station and the at least one secondary station, by the primary station transmitting a configuration message to the at least one secondary station, by the at least one secondary station adapting itself to receive configuration information signals transmitted by a source other than the primary station.

2. A method as claimed in claim 1, characterised in that the configuration information signals are transmitted by a broadcast transmitter.

3. A method as claimed in claim 1, characterised in that the at least one secondary station reconfigures itself in response to the configuration message.

4. A telecommunications system comprising a primary station and at least one secondary station, characterised in that the primary station has means for establishing a two-way communications link between it and the at least one secondary station, in that the at least one secondary station has means responsive to a configuration message transmitted by the primary station for preparing the secondary station to receive configuration message signals transmitted over at least a one-way channel other than the two-way communications link established between the primary station and the at least one secondary station.

5. A telecommunications system as claimed in claim 4, characterised in that the configuration message signals are transmitted by a source other than the primary station.

6. A telecommunications system as claimed in claim 4, characterised in that the at least one secondary station comprises a reconfigurable transceiver which is able to configure at least its receiver section to receive the configuration message signals.

7. A telecommunications system as claimed in claim 4, characterised in that at least one secondary station comprises a transceiver for communicating with the primary station over the two-way communications link and a receiver for receiving configuration message signals.

8. A telecommunications system as claimed in claim 4, characterised in that the configuration message signals are transmitted over a broadcast radio channel.

9. A secondary station for use in a telecommunications system comprising a primary station and the secondary station, the primary station having means for establishing a two-way communications link between it and the secondary station, characterised in that the secondary station has means responsive to a configuration message transmitted by the primary station for preparing the secondary station to receive configuration message signals transmitted over at least a one-way channel other than the two-way communications link established between the primary station and the secondary station.

10. A secondary station as claimed in claim 9, characterised in that said means adapts the secondary station to receive configuration message signals transmitted as broadcast signals.
